(19) United States
(12) Patent Application Publication
(10) Pub. No.: US 2005/0123143 A1
(43) Pub. Date: Jun. 9, 2005

(54) Audio reproduction system with a data feedback channel

(76) Inventors: Wilfried Platzer, Freiburg (DE); Christian Bock, Freiburg (DE)

Correspondence Address: Patrick J. O'Shea;O'Shea, Getz & Kosakowski, P.C., Suite 912, 1500 Main Street, Springfield, MA, 01115, US

(21) Appl. No.: 10/892,526

(22) Filed: Jul. 14, 2004

(30) Foreign Application Priority Data
Jul. 14, 2003 (DE) 103 31 757

(51) Int. Cl. G10F 1/22; H04H 5/00

(52) U.S. Cl. 381/2; 84/2

(57) ABSTRACT

The invention relates to an audio reproduction system with an audio signal delivery device (PC, S, VCR) to supply an audio signal (s, r), a data delivery device (S, A) to supply data (d, rd) for control and/or monitoring purposes, a mixing device (M) to mix the audio signal (r), and data (rd) before these are reproduced in combined form, at least one loudspeaker (L1-L5) to reproduce an acoustic sound signal (sw+sd), a receiving device (MIC, C) to receive the sound signal (sw+sd), and a receiver-side data processing device (PC, C) to process the data (sd) contained in the sound signal (sw+sd) and to trigger corresponding actions to be performed. In order to be able to handle arrangement errors for the loudspeakers, disturbances on the transmission paths of the audio signals to the loudspeakers, or preferred temporary locations of a listener (P), it is proposed that the data processing device (PC, C) together with the receiver for monitoring reproduction conditions be designed in a form analogous to a data feedback channel for the data (rd, sd) together with the audio signal delivery device (PC, S, VCR) and/or the data delivery device (S, A) for the purpose of controlling and/or monitoring these devices.

The invention relates to an audio reproduction system with a data feedback channel having the features indicated in the preamble of claim 1, and a method for reproducing at least one audio signal.

DE 698 07 499 T2 discloses an audio reproduction system which has an audio signal delivery device to supply an audio signal to be reproduced acoustically, a transmitter-side data delivery device to supply data for control and/or monitoring purposes, and a loudspeaker to reproduce an acoustic sound signal in the form of an audio signal. A sound signal is outputted through the loudspeaker, in which signal, in addition to the usual music signals, data or a corresponding data signal is mixed in such a way that for a person perceiving the sound waves at most a pseudo-noise code is detectable. The function of this audio reproduction system is to transmit data information from a central computer to LCD displays at a supermarket shelf, so that data and prices based on the transmitted data and matching the products on the shelf are displayed on the LCD displays. In another embodiment, alarm signals that are generated by a sensor and coded as data are transmitted by sound waves to a central alarm system. The receiving device that receives this sound signal mixed with data has a receiver-side data processing device to process the data contained in the sound signal and then to trigger corresponding actions to be taken.

In this system, the transmitter-side and receiver-side devices are essentially of analogous design, thereby enabling mutual communication.

In addition, the transmitter-side devices each have an internal noise level monitoring device to monitor the local noise level, the noise level being detected at times when the corresponding device is not transmitting any data to the remote device. As determined by the noise level detected during such time phases, a power adjustment circuit is triggered to control the power for subsequent data transmissions. As a result, the devices are either, on the one hand, in a receiving or a local-noise-level-detecting state, or, on the other hand, in a state transmitting data to a remote device.

The utilization of sound as a data carrier is known from “Schall als Datentrager” [“Sound as a Data Carrier”] in Elektronik Wireless of October 2002, pages 70-72. Here a data signal is converted so as to resemble an atonal component, then psycho-acoustically masked before being added to an actual audio signal. The audio signal is, for example, a signal similar to one transmitted in conventional applications in surround-sound systems through one or more loudspeakers. In particular, the audio signal is deliverable by an audio CD or a DVD or a radio receiver.

The audio signal thus mixed with a data signal is received by a microphone with an attached decoder designed to separate the data from the pure audio signal and from ambient noise. Applications include, for example, toys in the form of a figure that reacts in response to a data signal. The data signal corresponds here to action directions that are matched to a film displayed in parallel on a screen. In another area of application, mobile telephones are supplied through their microphones with informational data to be displayed on the mobile telephone display, the data then being transmitted through a loudspeaker system within a surrounding field.

In embodiments of this type, data signals are thus transmitted as sound waves to a remote device in order to trigger actions to be performed within the remote device.

Audio reproduction systems usually have a unidirectional data link running from a data source through requisite intermediate devices, such as amplifiers, to one or more loudspeakers as the end devices or data sinks which radiate sound waves corresponding to the audio signals. When required, requisite control data from preceding devices intended for following devices moves in the same direction as the radio or music distribution (streaming) and, especially in the case of digital methods, may be transmitted together with the useful data stream. With these streaming methods, however, a feedback channel is in some cases also required to monitor the functioning of the preceding devices. Although such a feedback channel for monitoring and control purposes requires a significantly lower data rate than the forward channel, the design complexity is high, and, as a result, this feature is normally excluded for reasons of cost.

When a control channel using the technology of the forward channel is implemented, not only the design complexity increases but the cost of the transmission path doubles as well. If the control channel is excluded, no means is available by which to affect preceding devices using the useful data stream.

For example, it is not possible to control a preceding data source such as a computer, CD player, or radio receiver from the amplifier. It is also not possible to control from a loudspeaker located in the immediate vicinity of the listener such preceding devices as amplifiers, CD players, or radio receivers which may be located far away from the listener.

In the case of an audio reproduction system using wireless transmission by radio or infrared to a remote loudspeaker, there is no means of providing feedback in the case of faulty transmission.

The goal of the invention is to propose an improved audio reproduction system which provides a data feedback channel having less design complexity.

This goal is achieved by an audio reproduction system having the features of claim 1, and by a method for reproducing an audio signal having the features of claim 8.

An audio reproduction system of this type has an audio signal delivery device to supply an audio signal as a useful audio signal, for example an audio signal from a video tape or compact disc (CD), a data delivery device to supply data for control- and/or monitoring purposes, a mixing device to mix the useful audio signal and the data to form a combined audio signal, and at least one loudspeaker to reproduce the acoustic sound signal generated from the combined audio signal. The concept of audio signal is to be interpreted broadly and comprises signal components, the allocated sound waves of which lie in a range that is both perceivable and nonperceivable by humans and animals. A microphone serves as the receiving device to receive the mixed or combined sound signal. In an extreme case, a microphone that detects only sound waves in the frequency range of the data signal components is sufficient. The signal received by the microphone is converted in the conventional way and fed to a receiver-side data processing device to process the data contained in the combined sound signal and to trigger the corresponding actions to be performed. In order to provide monitoring of the functionality of the following devices, the loudspeaker, and/or signal transmission in the direction of the loudspeaker from a preceding device of the audio reproduction system, the data processing device is designed in a form analogous to a feedback channel to monitor the audio reproduction system. In addition to supplementary data for monitoring purposes, direct control data may also be mixed in with the useful audio signals. In a system of this type, transmitter-side monitoring and control data are mixed in as data in the audio signal, then transmitted by the loudspeaker as sound waves. The sound waves received by the receiving device are then analyzed and fed to other transmitter-side components in order to implement on the transmitter side a monitoring of, for example, whether the original data have been correctly relayed and transmitted.

Whenever data are incorrectly transmitted—for example, because the transmission path is disturbed between the audio signal delivery device and the mixing device, or between the mixing device and the loudspeaker, or between the loudspeaker and sound receiving device—error-correction measures can be triggered in the form of actions to be performed. This situation must be understood in the broadest sense, so that disturbed or faulty transmission is understood to include improper arrangement of the loudspeakers within the space. Such an arrangement may result in the transmission of signals to the loudspeaker being disturbed. Improper positioning relative to a usual location for the person hearing the sound signals is also possible when using multiple loudspeakers, so that possibly only a correction of dynamics for one or more of the loudspeakers needs to be implemented. It is also possible for a simple spatial shifting of one loudspeaker to be sufficient.

In a corresponding method for reproducing at least one audio signal, the at least one audio signal is supplied for reproduction, at least one data value is supplied as data, the audio signal and the data value are mixed, the mixed signal is outputted through at least one loudspeaker as an acoustic signal, and the acoustic signal is received by a receiving device, after which on the receiver side the data contained in the received mixed signal are analyzed and processed to trigger corresponding actions to be performed. To provide a feedback channel for the purpose of controlling and monitoring the corresponding audio system itself, the data contained on the receiver side in the received sound waves are utilized to monitor or control the reproduction conditions in the transmitter-side devices and procedural steps.

A realization of the audio reproduction system or of the method is particularly advantageous in a surround-sound system for use with or in a computer or video/DVD player to reproduce multidimensional or multichannel audio signals. These surround-sound systems are normally used to reproduce the sound from films (videos).

Advantageous embodiments are discussed in the dependent claims.

Advantageously, the data delivery device for the transmitter-side supply, and possible mixing of data, and the data-processing device for the receiver-side processing of the data received via the sound waves, may be designed as an integrated device.

Its use is particularly advantageous in connection with loudspeakers which are coupled to the audio signal delivery device and/or the mixing device to transmit the audio signal and the data to the loudspeaker through a wireless interface. In the event the wireless interface is disturbed, sound waves with disturbed or completely missing data are received by the microphone, such that error-correction measures can be performed or triggered through the feedback loop to the transmitter-side devices. For example, another channel may be selected, or an instruction may be sent through a display device to the operator of the audio reproduction system.

The mixing device is advantageously designed to acoustically code or mix the data such that the data are not consciously perceivable by a human or animal listener so as to provide undisturbed enjoyment to the listener.

In audio reproduction systems having a plurality of loudspeakers, specifically, a plurality of loudspeakers that reproduce an internal audio signal or audio signal dependent on other audio signals, a feedback or return of the data mixed with the audio signals provides, after transmission as sound waves to the listener, an automatic regulating equalization of audio signal intensities. To effect control here, the receiving device * *[for] the sound waves, that is, an appropriate microphone is located at a central site, or preferably, at a site at which the person is located who is listening to the sound waves emitted by the loudspeakers. As a result, the individual audio signals for the different loudspeakers may be adjusted such that at the site of the listener a balanced audio signal is heard, and specifically, one that is uniform from all directions in terms of a uniform volume.

In particular, wireless loudspeakers which, in terms of spacing and design, are separated from the audio signal delivery device have a signal processing device specifically for useful audio signals, and advantageously have a mixing device to supply the mixed audio signal at the loudspeaker.

In terms of method, this type of audio reproduction system, specifically, one using a plurality of loudspeakers, enables audio signal preprocessing which can compensate for arrangement problems with the individual loudspeakers relative to each other, or for a specific position of a listener. Not only dynamic modifications to the individual audio signals can be compensated by this audio signal preprocessing but also any disturbing interference phenomena.

In the case of error messages which are relayed to the person operating the audio reproduction system, it is possible to use not only a display device—specifically, a display device of the audio reproduction system, or insertion of instructions into the display signal of a television receiver—but also an acoustic transmission of the error messages through at least one of the loudspeakers. For this purpose, a determination is made in the case of a plurality of loudspeakers as to which of the loudspeakers is able to output an optimal, or the most suitable possible, sound signal in order to output additional acoustic error messages through at least this loudspeaker.

In the case of these audio reproduction systems for local audio applications, specifically, those with wireless loudspeakers and audio transmission between the different audio components, it is possible to use the already existing audio components for a limited data feedback channel and to implement the data feedback channel as an audio path. The only items that must be provided on the side of the useful audio data source is an additional microphone and, if not already present, a data coder and data decoder in the form of a data delivery device or a general data processing device.

In a home audio system, the data source—for example, a computer (PC), CD player (CD: compact disc), or radio as the music source supplies audio data in analog or digital form. If it is necessary to learn the status of the data sink, a wireless loudspeaker, or an active loudspeaker, in order to determine whether these are present, ready, turned on, and problem-free, it is possible to transmit this information within the audio signal outputted by the loudspeaker as data. Since the data rate is very low, the return data can be processed such that they can be hidden in the normal audio signal within or outside of the audible range by a signal processing device. Located in the device of the data source are a microphone to pick up the audio signals and a signal processing device to recapture the data from the audio signal.

It is advantageously also possible to integrate an input for interactions of the user in equipment and devices between the audio signal source and music source, and the loudspeakers, or within these items—that is, for example, switches or IR detectors (IR: infrared signal). These data are then also transmitted as a data signal through the acoustic path from the loudspeaker to the microphone which is coupled to the corresponding device of the audio signal source.

One embodiment and modifications are explained below based on the drawings.

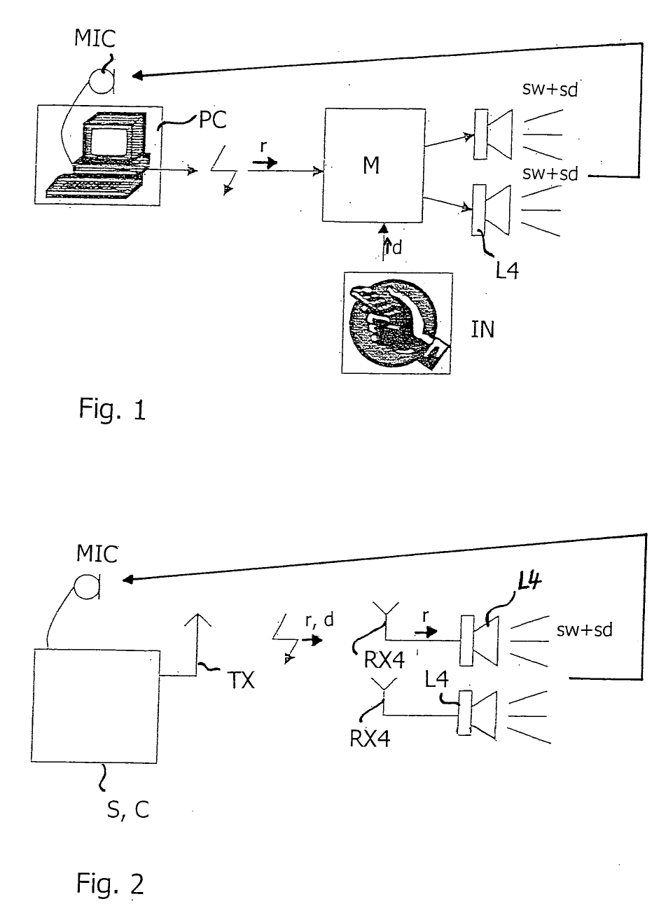

FIG. 1 is a schematic view of a system having a computer as the audio signal source, and a user input device in the area of the audio signal receiving device at the loudspeakers to reproduce a corresponding audio signal;

FIG. 2 shows a music source with wireless interfaces to the loudspeakers;

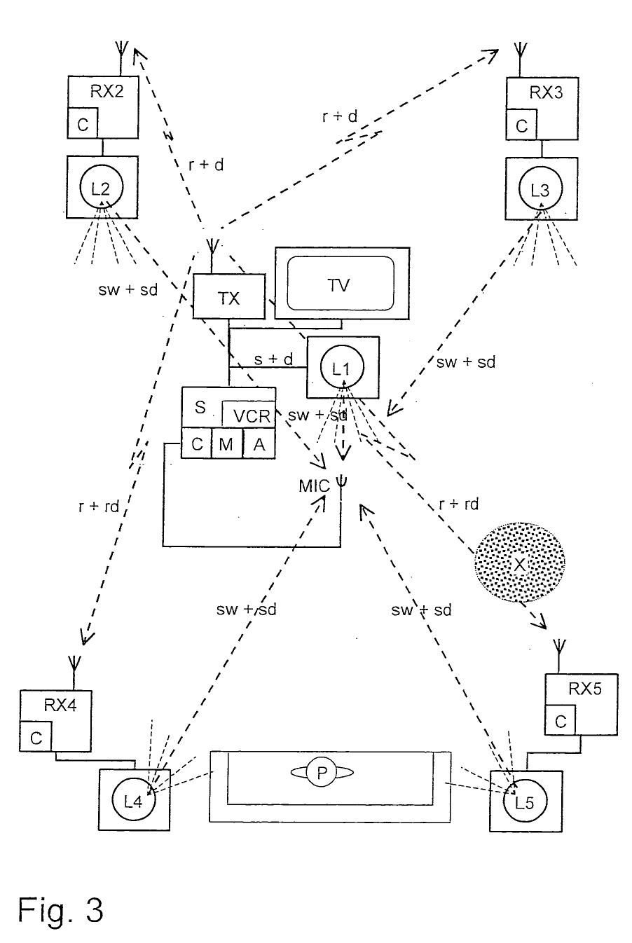

FIG. 3 shows an arrangement of an audio reproduction system in connection with a surround-sound system, and

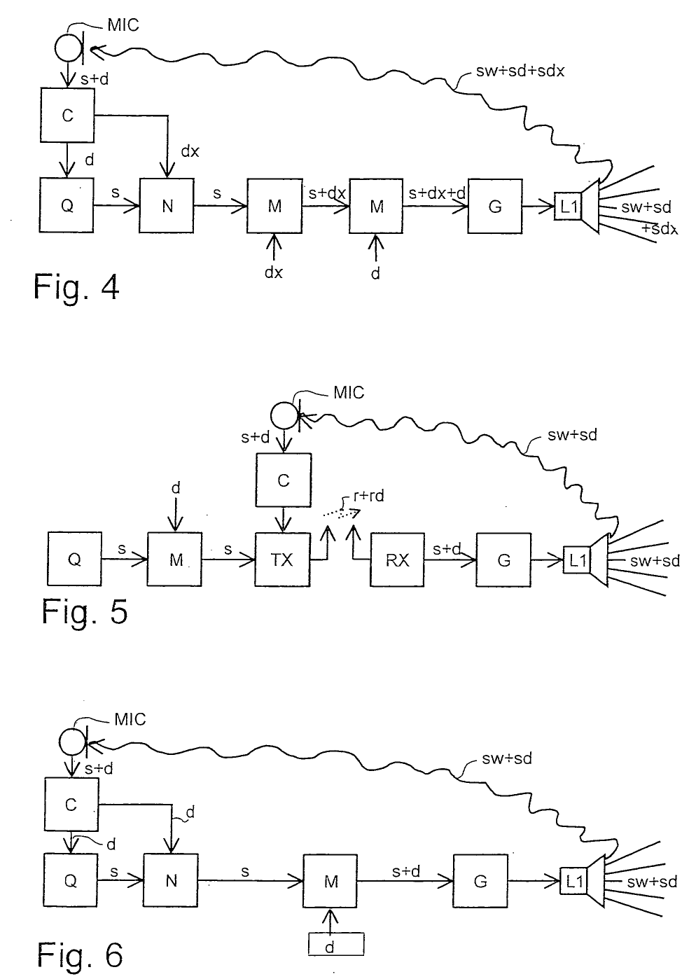

FIGS. 4-7 show various modifications of these arrangements.

As FIG. 1 shows, a simple arrangement of an audio and sound reproduction system is composed of an audio delivery device in the form of a computer PC, a data processing device which also acts as the mixing device M, an input device IN as the user input unit, and loudspeakers connected to data processing device M, as well as a receiving device in the form of a microphone MIC connected directly to computer PC.

Computer PC here serves as the audio signal source and supplies, for example, audio signals in the form of music. The audio signal is transmitted in a form analogous to datastreaming through an interface to the data and audio signal processing device with mixer M. This transmission occurs unidirectionally, with, specifically, audio signals, response signals, and data being transmitted. The transmission can be implemented in the conventional manner, specifically, electromagnetically, electrically or optically. The interface here may, specifically, be in the form of a wireless interface, cable-type interface, or optical interface. The data and audio signal processing device together with mixing device M receives this data stream, including in particular audio signal r as the useful audio signal, and processes the audio signal in the form of a combined or mixed audio signal for reproduction through the connected loudspeakers L4. In addition, the data and audio signal processing device together with mixing device M receives data d from user input device IN. User input device IN may, for example, be a known remote control, such as those used to operate television sets, music systems, and stand-alone surround-sound systems.

In mixing device M, this data d or a corresponding data signal is mixed with audio signal r. The mixing is appropriately implemented here based on psycho-acoustic criteria so that the listener is able to consciously perceive the acoustically reproduced audio signals sw but not the acoustically reproduced data signals sd.

The sound waves sw+sd, together with audio signal component sw and data signal component sd, are received through receiving device MIC, then fed as the received audio signal to computer PC serving as the universal data processing device. In data processing device PC, data d is mixed or encoded with audio signal r in mixing device M, extracted from the received sound signal sw+sd, then decoded. The received data d is then analyzed in order to perform any actions that need to be implemented.

Decoding can be supported specifically by using known correlation procedures. The analysis can be governed by various purposes. For example, the analysis may be used to determine whether loudspeaker L4 is functioning properly, or at all. In the event of incorrect positioning or the use of a stereo microphone, it may be a matter, for example, of reversing the arrangement of a right and left loudspeaker which then receive transmission of the respective opposite audio signal. Also possible is a correction of interference caused by incorrect positioning or design differences in the loudspeakers. Another example of possible correction consists in controlling the various loudspeakers having individually varying signal intensities so as to drive with a higher signal intensity a loudspeaker which is further removed from a central location than the other loudspeaker. Corrective measures of this type can, preferably, be performed automatically by the audio reproduction system, and specifically automatically by the data processing device or data delivery device PC.

Additionally or alternatively, manual correction is also possible after the user has been informed about a malfunction or about an appropriate correction. Messages of this type can be provided, for example, through the display of the computer PC, a display of the attached television set, special display elements in the data and audio signal processing device, or acoustically through the loudspeakers.

FIG. 2 shows an embodiment in which the audio signal delivery device S is used as a music system having a music source, for example a CD player. Audio signal delivery device S has a wireless interface TX which serves to transmit audio signals r and a data signal d through an interface to wireless interface receivers RX4. Wireless interface receivers RX4 receive the audio signal r and relay this to a loudspeaker L4 which, using a preceding preprocessing device, mixes or encodes received audio signal r as the useful audio signal with data signal d, then outputs a sound signal sw+sd which contains audio signal components sw as the useful audio signal components and data signal components. To provide the feedback, microphone MIC functions as a receiving device, which is connected to a data processing device which in turn performs decoding, correlation, analysis and initiation of actions. This data processing device C is appropriately a component of the audio signal delivery device, or is coupled to it in order to modify in advance audio signals subsequently to be outputted or supplied.

FIG. 3 represents another embodiment in the form of an audio reproduction system as a component of a video reproduction device to reproduce films having surround-sound audio signals and a corresponding plurality of loudspeakers L1-L5. In terms of the individual components and procedures, general reference is made to the two embodiments described based on FIGS. 1 and 2. The audio signal delivery device S shown generates, in addition to audio signal r, a video signal which is supplied, for example, by a DVD player (DVD: digital versatile disc) or by a video player such as a video recorder VCR. For control purposes, audio and video signal delivery device S, VCR, has a control device C that advantageously takes on the functions of the data delivery device and, optionally, of mixing device M. In addition, this central unit of the audio reproduction system advantageously has a display and input device A through which a person P operating the system can receive information and control instructions. A microphone MIC connected to the central device S serves as a receiving device to pick up sound waves sw+sd arriving at the location of microphone MIC, and to feed these to a receiver-side data processing device which again is in the form of control device C, according to a preferred embodiment.

The audio signal delivery device and data processing device send an audio signal s or data signal d to mixing device M which outputs a corresponding mixed signal. This signal s+d is then fed to loudspeakers L1-L3, L5. In the embodiment shown, first loudspeaker L1 is connected by a cable to the central system with mixing device M through which it has the to-be-converted signal s+d mixed in the sound waves fed to it directly. Additional loudspeakers L2, L3, L5 have signal r+rd together with audio signal r already mixed in mixing device M, and data signal rd, fed to them through an interface. The interface is formed by a wireless interface transmitter TX and a wireless interface receiver RX2, RX3, RX5. Wireless interface receivers RX2, RX3, RX5 implement a preprocessing of the received mixed signal r+d using control device C, then feed a corresponding signal to the designated loudspeaker L2, L3, or L5. These convert the received mixed signal to sound waves sw+sd and emit these to the environment. In the manner already described, these sound waves are then picked up by microphone MIC and relayed through a kind of feedback or return through the feedback channel to the receiver-side data processing device C for decoding, analysis, and possible initiation of corrective measures.

Corrective measures may be required for multiple reasons, as have already been described. The case in the example illustrated involves an obstacle X which interferes with the wireless path between wireless interface TX and one of the wireless interface receivers RX5. As a result of the interference with the mixed wireless signal, corresponding loudspeaker L5 emits a correspondingly modified or disturbed sound wave pattern sw+sd. This is detected by microphone MIC and fed to the control device in the central unit. Corresponding displays at display and input device A, acoustic warning messages through one or more of loudspeakers L1-L5, or, for example, even a corresponding insertion of a warning message or notification in the display screen of an attached television set TV, enable the user of the music system to be informed whether the disturbance is correctable, and if so, how this disturbance can be corrected. To the extent feasible, automation of the process can be provided which automatically initiates corrections such as a change of channel or an increase in the transmission power.

As illustrated, microphone MIC as the receiving device is located at the central location device, together with the audio delivery device and the data processing device, and connected to the latter device. However, variable positioning of microphone MIC is also possible, the microphone being connected to the data processing device through a long cable connection, or optionally also through a wireless interface transceiver device. A mobile microphone MIC of this type can be used to provide optimal reproduction at a selected reception site or, if the microphone is being carried by a person P listening to the music, continuously at his momentary reception site. To this end, those audio signals r which are normally different for the various loudspeakers L1-L5 are also assigned specially designated data signals rd. Through microphone MIC, the correspondingly mixed sound waves sw+sd are received and relayed for analysis to data processing device C. Based on variations in propagation time or variations in signal intensity, to name examples of parameters, data processing device C is able to determine the signal intensity for the sound waves sd of the individual loudspeakers. In response, for example, audio signal r for a loudspeaker located close to microphone MIC can accordingly be reduced in intensity, while audio signal r for a loudspeaker at a remote location can be increased in intensity.

As these examples illustrate, a plurality of applications for such an audio reproduction system or corresponding procedure is possible. First, application-specific actions such as correction of dynamics can be performed, and second, audio reproduction system monitoring measures can be initiated and implemented. For example, a loudspeaker L5 or its wireless interface receiver RX5 can be relocated in the event an obstacle X is blocking data transmission between these two.

Whereas a signal s+d, r+rd that has already been mixed from audio signal and data signal in central mixing device M is fed to the described loudspeakers L1-L3, L5, in the present and preferred embodiment, the audio signal r in the form of an separate signal is fed to another loudspeaker L4, or to its wireless interface receiver RX4. Encoding or mixing with a data signal rd is implemented in the preprocessing device RX4 with the attached wireless interface receiver before the thus mixed signal is fed to loudspeaker L4 for conversion to sound waves sw+sd. The data signal or data rd can be transmitted parallel to the audio signal by central device components to loudspeaker-preprocessing device RX4; however, these can also be supplied to this device from a memory or through a suitable input device for mixing in mixing device M, mixing device M being located in loudspeaker-preprocessing device RX4.

In the embodiments, there is thus an audio signal source, the audio signal of which is outputted from the loudspeakers in a form mixed with a data signal. The sound waves of the loudspeakers form the data feedback channel to a microphone connected to a data processing device. This device serves to control and/or monitor the audio signal reproduction.

Additional exemplary arrangements for realizing the audio reproduction system or procedure are illustrated in FIGS. 4-8. These again start with the known basic principle that a useful audio signal is outputted from a source Q and that these useful audio data s together with supplementary data d, dx undergo psycho-acoustic data processing and mixing of in a mixing device M. The thus-mixed combined audio data are fed through additional devices G, TX, RX, as necessary, to a loudspeaker L1, then outputted through the speaker as mixed sound waves sw+sd, sw+sd+sdx. These mixed sound waves are received by a microphone MIC and fed as an appropriately converted audio signal or audio data stream to [ . . . ]¹ as a detector. The detector may preferably be a general data processing device C which uses correlation to extract the supplementary data stream from the received sound signal. This process thus provides the advantageous monitoring and/or control of the following devices by supplementary data d, dx transmitted together with the data stream. In principle, various methods are possible—specifically, time multiplexing, frequency multiplexing and code multiplexing may be employed. In this procedure, the direction of control or transmission of control data d, dx as the supplementary data matches the direction of the audio streaming.
¹ Translator's note: text apparently missing.

Specifically, these arrangements provide a data feedback channel, that is, control of the preceding devices by the subsequent or following devices through a loop which is closed by the sound path between loudspeaker L1 and microphone MIC.

Specifically, the above provides control and regulation of the transmission path and the audio emission. A data channel of this type may be used specifically in the form of a feedback channel for external interfaces, for example a user interface utilizing wireless or infrared, wherein the user signal d is fed to a following device and transmitted over the gap to a device preceding the feed-in point M. Specifically, what is involved is preferably control of preceding devices by following devices using a combination of the sound path and combined streaming channel.

In the embodiment illustrated in FIG. 4, useful audio data are supplied as audio signal s by data source Q and fed to another following device N. Audio data s are modified by following device N, or relayed in modified form to mixing device M. In mixing device M, external supplementary data dx are mixed with the audio signal or audio data. Mixing is based here on psycho-acoustic criteria. The mixed audio signal s+dx is then fed to another mixing device M in which additional supplementary data d are mixed in. This additional supplementary data d may, for example, be internal supplementary data to monitor the transmission path to another following device G, or from a following device G through loudspeaker L1 to microphone MIC. What loudspeaker L1 outputs are thus mixed sound waves having a useful audio signal component sw, a first supplementary data sound wave component sw, and a second supplementary data sound wave component sdx. The sound waves thus mixed are received by microphone MIC and fed as an audio signal to a detector, for example central control device C of a music system or of a computer. The received data is analyzed by control device C and appropriate control instructions outputted to the devices Q, N preceding mixing devices M, M. Specifically, it is possible here to insert various devices Q, N separately.

FIG. 5 shows an embodiment in which useful audio signal s is fed directly to mixing device M from signal source Q as the data delivery device. Supplementary data is mixed in, in this device. Mixed signal s+d is then fed to transmission device TX which converts the received mixed signal s+d to wireless signal r+rd, then transmits this wireless signal over a wireless path to receiving device RX. In the ideal case, the received wireless signal r+rd is converted by receiving device RX back into audio signal s+d. Whenever a disturbance occurs on the wireless path, however, a modified audio signal is supplied by receiving device RX. This audio signal is fed to another device G, for example an amplifier, which processes the audio signal and feeds it to loudspeaker L1. This then generates sound waves which again contain both audio signal data and supplementary data and are picked up by microphone MIC. Microphone MIC in turn supplies appropriately mixed received audio signal data to data processing device C. In the embodiment shown, the supplementary data preferably serves to monitor the wireless path, and control device C or data processing device C are thus linked to transmission device STX in order to transmit these control instructions. The control instructions may be used, for example, to change the transmission power on a high-frequency channel.

FIG. 6 shows an embodiment similar to that of FIG. 4, and for this reason, reference is made to the description of FIG. 4 in regard to the individual design components, signal and data components, and procedural steps. In the embodiment shown, inputted supplementary data d come from a remote control which enables the user to input control data for devices or equipment Q, N of the audio reproduction system that precede mixing device M. A user is thus able to employ an input device—such as an infrared remote control, wireless remote control, or mechanical input elements—to control preceding devices Q, N at the mixing device.

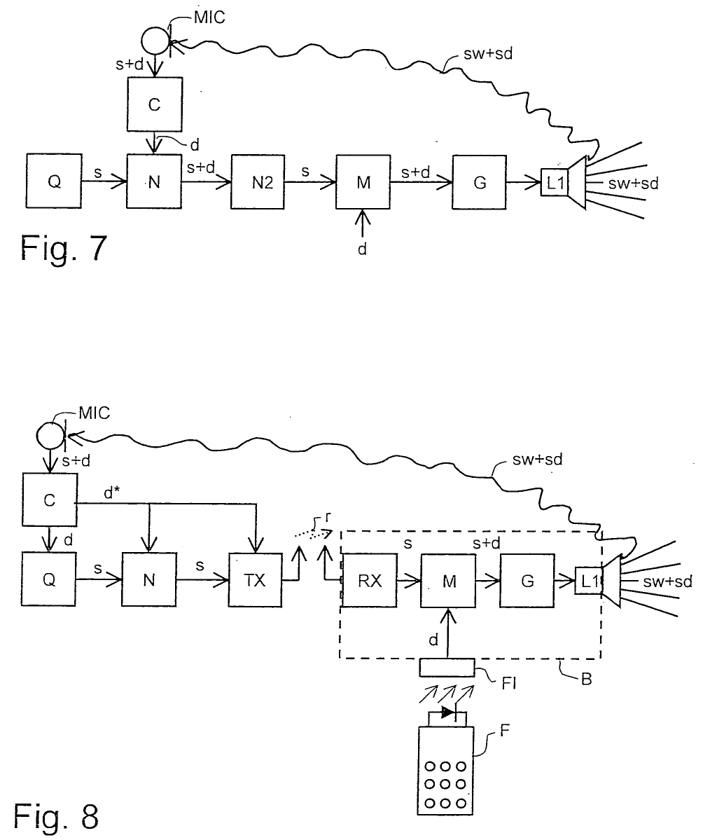

FIG. 7 represents an embodiment in which mixing device M is a device which follows the other equipment or devices, which device serves to input control instructions d in the form of supplementary data. The following devices are controlled by mixing device M, in the form of a following device, through the loop composed of the sound path and streaming channel. In this case, for example, it is not the data processing device in the form of data source Q but a device N following this device, or additional devices preceding it, which are controlled.

FIG. 8 represents another variant of an embodiment in which a user of an audio reproduction system is able to employ a remote control F through a corresponding remote-control opposite interface. In this embodiment, a loudspeaker box is removed from the other components of the audio reproduction system through an interface, specifically a wireless interface or infrared interface. Audio signal r is thus received by receiving device RX of loudspeaker box B, so that receiving device RX of loudspeaker box B ideally passes a correctly reconstructed audio signal s to mixing device M. Data d in the form of supplementary data are fed to mixing device M. This supplementary data comes from a direct input device at loudspeaker box B or remote control opposite interface F1. The mixing device M mixes this supplementary data d with audio signal s and feeds the mixed or combined signal to another device G which implements, for example, amplification in order to feed the amplified signal to loudspeaker L1. Loudspeaker L1 outputs a mixed sound signal sw+sd in the manner describe above which [is]² received by microphone MIC and converted from audio signal components s and data signal components d to a mixed signal. This mixed signal is in turn fed to the data processing device. As required, this device can then control individual or all preceding equipment Q, N, TX of the audio reproduction system ahead of the wireless interface to loudspeaker box B.
² Word added by translator.

1. Audio reproduction system with a feedback channel, comprising
an audio signal delivery device (PC, S, VCR) to supply an audio signal (s, r);
a data delivery device (S, A) to supply data (d, rd) for control and/or monitoring purposes;
a mixing device (M) to mix the audio signal (r) and the data (rd) before their combined reproduction;
at least one loudspeaker (L1-L5) to reproduce an acoustic sound signal (sw+sd) generated from the audio signal (r) and the data (rd);
a receiving device (MIC, C) to receive the sound signal (sw+sd); and
a receiver-side data processing device (PC; C) to process the data (sd) contained in the sound signal (sw+sd) and to trigger corresponding actions to be performed;
characterized in that
the data processing device (PC; C) together with the receiving device is in the form of a data feedback channel for the data (rd, sd), including a device preceding the loudspeaker, specifically, the audio signal delivery device (PC; S, VCR), and/or data delivery device (S, A), to control and/or monitor these devices.

2. Audio reproduction system according to claim 1, in which the data delivery device and the data processing device are in the form of an integrated device (C, PC).

3. Audio reproduction system according to claims 1, in which the at least one loudspeaker (L2-L5) is connected to the audio signal delivery device (S, VCR) and/or the mixing device (M) in order to transmit the audio signal (r) and the data (rd) through an air or wireless interface.

4. Audio reproduction system of claim 1, in which a dedicated signal processing device (C) and the mixing device (M) are assigned to the at least one loudspeaker (L4) in terms of space and design.

5. Audio reproduction system according to claim 1, in which the mixing device (M) is designed to implement psycho-acoustic coding and mixing of the data (rd, sd) such that the data cannot be consciously perceived by a human or animal listener (P).

6. Audio reproduction system of claim 1, comprising a display device (A; TV) for displaying measures required by an operator (P) to enable or improve reproduction conditions.

7. Audio reproduction system according to claim 4, in which the data processing device (C) and the audio signal delivery device are designed to automatically regulate audio signal intensities for different audio signals out of a plurality of audio signals for different loudspeakers (L1-L5) relative to each other.

8. Method for reproducing at least one audio signal (r), comprising an audio reproduction system, specifically, comprising an audio reproduction system according to a foregoing claim, in which
the at least one audio signal (r) is supplied for reproduction;
at least one data value or data signal is supplied as data (rd);
the audio signal (r) and the data value (rd) are mixed;
the mixed signal (r+rd, s+sd) is emitted through at least one loudspeaker (L1-L5) as an acoustic signal (sw+sd);
the acoustic signal (sw+sd) is received by a receiving device (MIC); and
on the receiver side, the received data (sd, rd) is processed to trigger corresponding actions to be performed;
characterized in that
the data contained on the receiver side (sd, rd) is utilized in a form analogous to feedback data for the transmitter-side procedural steps.

9. Method according to claim 8, in which monitoring is used to determine and display arrangement problems for individual loudspeakers (L1-L5) out of a plurality of loudspeakers used in the audio reproduction system, or corresponding audio signal preprocessing is used to correct these problems, specifically, to regulate these problems in terms of dynamics and/or phase position.

10. Method according to claims 8, in which monitoring is used to determine and display disturbing interference phenomena for individual loudspeakers (L1-L5) out of a plurality of loudspeakers used in the audio reproduction system, or corresponding audio signal preprocessing is used to correct these interference phenomena.

11. Method according to claim 8, in which the receiving device (MIC) is located at the desired temporary location of the listener (P) and the audio signal reproduction is regulated accordingly through individual loudspeakers (L1-L5) out of a plurality of loudspeakers used in the audio reproduction system, specifically, in terms of dynamics and/or phase position.

12. Method according to claim 8, in which error messages are outputted optically through a display device (A; TV) or acoustically through at least one loudspeaker of the audio reproduction system (L1-L4), which loudspeaker has been determined to be functional.

13. Method according to claim 8, in which the acoustic signal (sw+sd) is used as the data feedback channel to control devices preceding the loudspeaker (L1-L5).

14. Method according to claim 8, in which the data (sd, rd, d) contained on the receiver side is used to monitor and/or control the transmission path and the emission of sound.

15. Method according to claim 8, in which the acoustic signal (sw+sd) is used as the feedback channel for a data input device (F, Fi) preceding the loudspeaker (L1-L5) to control preceding devices.

16. Method according to claim 8, in which preceding devices are controlled by following devices (M) through a combination of the sound path and the streaming channel to form a data feedback channel.

17. (canceled)
